(19) United States
(12) Patent Application Publication
(10) Pub. No.: US 2018/0204148 A1
(43) Pub. Date: Jul. 19, 2018

(54) MANAGEMENT SYSTEM, MANAGEMENT METHOD, AND COMPUTER-READABLE RECORDING MEDIUM

(71) Applicant: FUJITSU LIMITED, Kawasaki-shi (JP)

(72) Inventors: Takehiko Nishimura, Kawasaki (JP); Kazuki Takahashi, Wako (JP)

(73) Assignee: FUJITSU LIMITED, Kawasaki-shi (JP)

(21) Appl. No.: 15/922,388

(22) Filed: Mar. 15, 2018

Related U.S. Application Data
(63) Continuation of application No. PCT/JP2015/077361, filed on Sep. 28, 2015.

(51) Int. Cl. G06Q 10/06; G05B 19/418; G06Q 50/04

(52) U.S. Cl. CPC G06Q 10/063; H04W 4/38; G06Q 50/04; G05B 19/418

(57) ABSTRACT

A management system that performs, based on sensor information received from a sensor disposed in a manufacturing area, process management in the manufacturing area, the management system includes: a memory; and a processor coupled to the memory, wherein the processor executes a process including: acquiring information on a pause time slot of work in the manufacturing area; and displaying, when displaying temporal transition of a manufacturing process on a time axis based on the sensor information, the temporal transition on a display after having compressed duration from a start time to an end time of the acquired pause time slot.

### CROSS-REFERENCE TO RELATED APPLICATION

This application is a continuation of International Application No. PCT/JP2015/077361, filed on Sep. 28, 2015, the entire contents of which are incorporated herein by reference.

### FIELD

The embodiment discussed herein is related to a management system, a management method, and a computer-readable recording medium.

### BACKGROUND

Data related to action of companies is accumulated and efficiently used. For example, data related to operation logs or the like of manufacturing apparatuses in assembly lines of products is accumulated and efficiently used to improve manufacturing processes. Furthermore, as the data, log information is sometimes recorded at the timing of the start and/or the end of each of the processes.
Patent Document 1: Japanese Laid-open Patent Publication No. 2015-075795

By acquiring the log information on each of the processes, it is conceivable to make use of grasping the entire state of a manufacturing process. For example, in a series of manufacturing processes of sequentially assembling a plurality of parts, it is assumed that, every time each of the parts is picked up from a storage site for the manufacture, the pickup time is recorded as log information. In this case, the length of time between the pickup time of a part A and the pickup time of a part B can be assumed to be working time needed for a process of assembling the part A.

However, when a product is assembled at the step of a certain process, if a worker starts to take a break before the end of work performed at the step of the process, there may be a case in which this state is recorded as the working time including the break time. Namely, when considering a case of simply calculating the working time that has been needed for each of the processes based on only the log information indicating the start and/or the end of the processes, there may be a case in which the working time is recorded longer than the actual working time needed for the worker to finish the work.

### SUMMARY

According to an aspect of an embodiment, a management system that performs, based on sensor information received from a sensor disposed in a manufacturing area, process management in the manufacturing area, the management system includes: a memory; and a processor coupled to the memory, wherein the processor executes a process including: acquiring information on a pause time slot of work in the manufacturing area; and displaying, when displaying temporal transition of a manufacturing process on a time axis based on the sensor information, the temporal transition on a display after having compressed duration from a start time to an end time of the acquired pause time slot.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of a management system according to an embodiment;

FIG. 2 is a diagram illustrating an example of a break time master;

FIG. 3 is a diagram illustrating an example of a log storage unit;

FIG. 4 is a diagram illustrating an example of a correction log storage unit;

FIG. 5 is a diagram illustrating an example of break time between processes;

FIG. 6 is a diagram illustrating an example of a graph in a case where break time is not considered at the time of normal display;

FIG. 7 is a diagram illustrating an example of a graph in a case where break time is considered at the time of normal display;

FIG. 8 is a diagram illustrating another example of a graph in a case where break time is not considered at the time of normal display;

FIG. 9 is a diagram illustrating another example of a graph in a case where break time is considered at the time of normal display;

FIG. 10 is a flowchart illustrating an example of display processing according to the embodiment; and

FIG. 11 is a diagram illustrating an example of a computer that executes a management program.

### DESCRIPTION OF EMBODIMENTS

Preferred embodiment of a management system, a management method, and a management program disclosed in the present invention will be described in detail below with reference to the accompanying drawings. Furthermore, the disclosed technology is not limited to the embodiment. Furthermore, the embodiment described below may also be used in any appropriate combination as long as the processes do not conflict with each other.

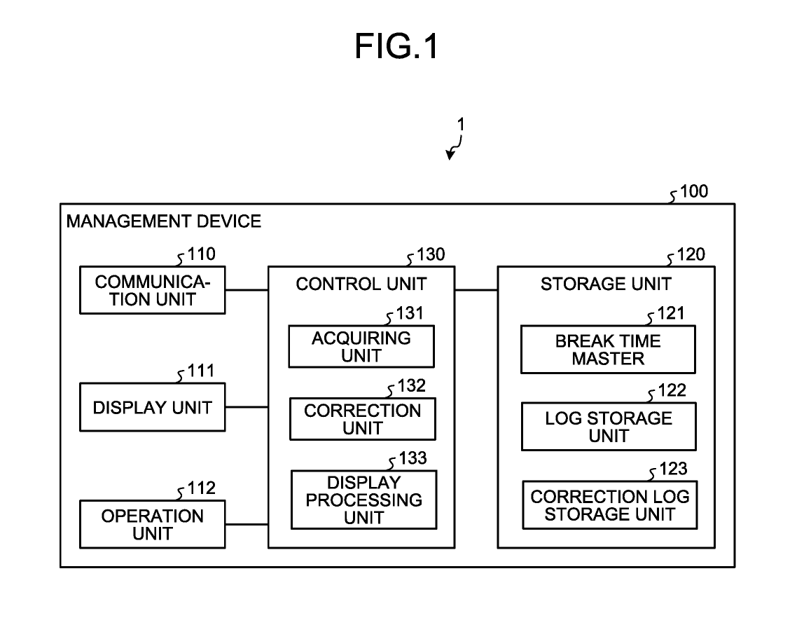

FIG. 1 is a block diagram illustrating an example of the configuration of a management system according to an embodiment. A management system 1 illustrated in FIG. 1 includes a management device 100. The management system 1 may also include, in addition to the management device 100, for example, a control device for each of manufacturing processes, a control device for a machine tool, various testing devices used for temperature tests or the like, a sensor that manages products and processes, or the like. The management device 100 can acquire log data and sensor information from various devices. The sensor reads information on, for example, a radio frequency identifier (RFID) tag that is attached to a product. Furthermore, the management system 1 may also include a terminal device used by an administrator. The management device 100 and the various devices are connected via a network (not illustrated) so as to be capable of communicating with each other. In a description below, a case in which various kinds of information on an assembly line of a product are acquired as log data will be described as an example. Furthermore, in the embodiment, it is assumed that four processes, i.e., processes A to D, are present in a manufacturing area and it is assumed that, regarding the product to be manufactured, the work in each of the processes is sequentially performed in the order starting from a process A.

The management system 1 illustrated in FIG. 1 performs process management in a manufacturing area based on the sensor information received from a sensor disposed in a manufacturing area. Furthermore, the sensor information can use log data on operations or the like acquired from various devices. The management device 100 in the management system 1 acquires information related to a pause time slot of work in the manufacturing area. Furthermore, the information on the pause time slot is information on, for example, the break time and is previously input by an administrator. When the management device 100 displays, on the time axis, temporal transition of the manufacturing process based on the sensor information, the management device 100 displays the temporal transition on a display unit 111 after having compressed duration from the start time to the end time of the acquired pause time slot. Consequently, the management device 100 can display the temporal transition of the manufacturing process by taking into consideration of the pause time slot.

As illustrated in FIG. 1, the management device 100 includes a communication unit 110, the display unit 111, an operation unit 112, a storage unit 120, and a control unit 130. Furthermore, in addition to the functional units illustrated in FIG. 1, the management device 100 may also include various functional units, such as various types of input devices and audio output devices, that are included in a known computer.

The communication unit 110 is implemented by, for example, a network interface card (NIC) or the like. The communication unit 110 is a communication interface that is connected to various devices via a network (not illustrated) in a wired or wireless manner and that manages communication of information with the various devices. The communication unit 110 receives log data from the various devices. The communication unit 110 outputs the received log data to the control unit 130.

The display unit 111 is a display device for displaying various kinds of information. The display unit 111 is implemented by, for example, a liquid crystal display or the like as the display device. The display unit 111 displays various screens, such as a display screen, that is input from the control unit 130.

The operation unit 112 is an input device that receives various operations from an administrator of the management system 1. The operation unit 112 is implemented by a keyboard, a mouse, or the like as, for example, an input device. The operation unit 112 outputs the operation that was input by the administrator to the control unit 130 as operation information. Furthermore, the operation unit 112 may also be implemented by a touch panel or the like as an input device. The display device of the display unit 111 and the input device of the operation unit 112 may also be integrated as a single unit.

The storage unit 120 is implemented by, for example, a semiconductor memory device, such as a random access memory (RAM) or a flash memory, or a storage device, such as a hard disk or an optical disk. The storage unit 120 includes a break time master 121, a log storage unit 122, and a correction log storage unit 123. Furthermore, the storage unit 120 stores therein information that is used for the processes performed in the control unit 130.

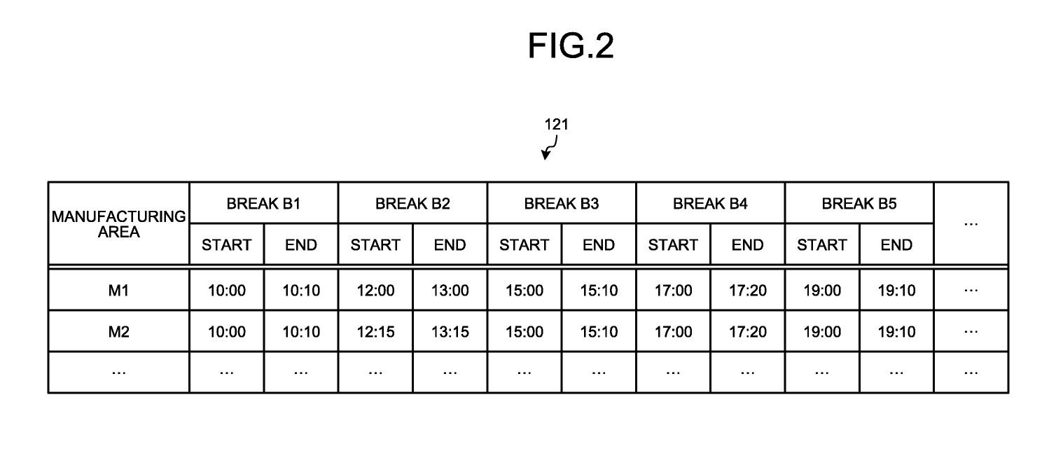

The break time master 121 stores therein a break time master in which pieces of break time are set in each manufacturing area. FIG. 2 is a diagram illustrating an example of the break time master. As illustrated in FIG. 2, the break time master 121 has items, such as “manufacturing area”, a “break B1” to a “break B5”, and “start” and “end” for each break. The break time master 121 stores therein information, for example, for each manufacturing area as a single record.

The “manufacturing area” is information indicating the manufacturing location of a product in a plant or the like. The “break B1” to the “break B5” is information indicating the break time of each of the workers in the plant. The “start” is information indicating the start time of the break time. The “end” is information indicating the end time of the break time. In the example in the first line illustrated in FIG. 2, regarding a manufacturing area “M1”, it is indicated that the first break of the “break B1” starts at “10:00” and ends at “10:10” and it is indicated that the second break of a “break B2” starts at “12:00” and ends at “13:00”. In the same manner, each of the breaks is associated with the start and end time of the corresponding break. Namely, the “break B1” indicates a break in the morning, the “break B2” indicates a break at noon, a “break B3” indicates a break in the afternoon, a “break B4” indicates a break after regular working time, and the “break B5” indicates a break during overtime.

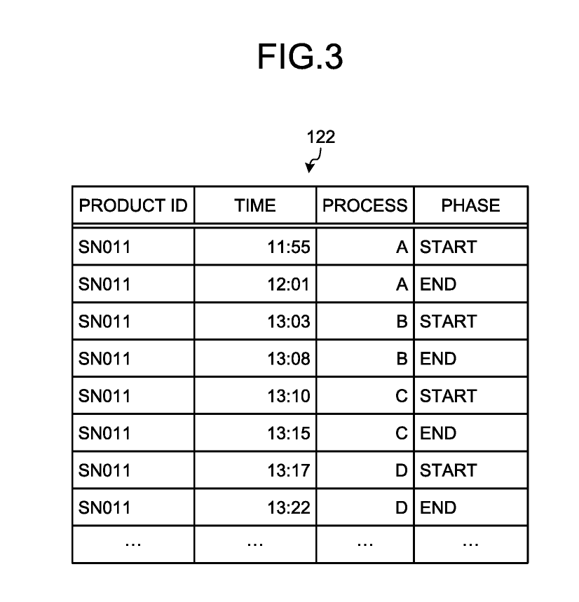

A description will be given here by referring back to FIG. 1. The log storage unit 122 stores therein log data on events in each of the processes for each product. FIG. 3 is a diagram illustrating an example of a log storage unit. As illustrated in FIG. 3, the log storage unit 122 has items, such as “product identifier (ID)”, “time”, “process”, and “phase”. The log storage unit 122 stores therein information, for example, for each event as a single record.

The “product ID” is an identifier for identifying a product. The “time” is information indicating the time at which an event occurred. The “process” is information indicating a process in which the event has occurred. The “phase” is information indicating the state of the event, such as the start or the end of the event. In the example in the first line illustrated in FIG. 3, it is indicated that the product with a product ID “SN011” “starts” the process “A” at “11:55”.

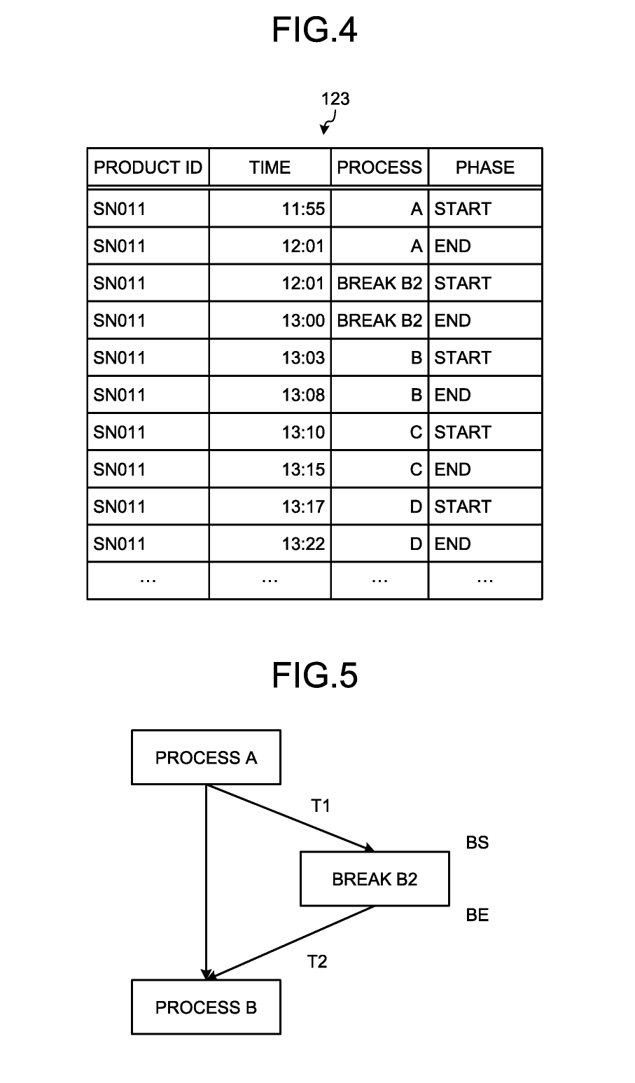

A description will be given here by referring back to FIG. 1. The correction log storage unit 123 stores therein, based on the break time master and the log data, correction log data into which actual break time is inserted. FIG. 4 is a diagram illustrating an example of the correction log storage unit. As illustrated in FIG. 4, the correction log storage unit 123 has items, such as “product ID”, “time”, “process”, and “phase”. The correction log storage unit 123 stores therein information, for example, for each event as a single record.

The “product ID” is an identifier for identifying a product. The “time” is information indicating the time at which an event occurred. The “process” is information indicating a process in which the event has occurred. The “phase” is information indicating the state of an event, such as the start or the end of the event. In the correction log storage unit 123 illustrated in FIG. 4, when compared with the log storage unit 122 illustrated in FIG. 3, the third line and the fourth line associated with the start time and the end time, respectively, of the break time are inserted. Furthermore, in the third line, because the time indicated in the second line is “12:01”, the start of the break time is corrected from “12:00” to “12:01”. At this time, if the time of a process B is calculated from the process A, normally, the start time of the process B−the end time of the process A=13:03−12:01=1:02. The period of time from the process A to the process B will be, when taking into consideration the break B2, (start time of the process B−end time of the process A)−(end time of the break B2−start time of the break B2)=(13:03−12:01)−(13:00−12:01)=0:03.

A description will be given here by referring back to FIG. 1. The control unit 130 is implemented by, for example, a central processing unit (CPU), a micro processing unit (MPU), or the like executing, in a RAM as a work area, the program that is stored in an inner storage device. Furthermore, the control unit 130 may also be implemented by, for example, an integrated circuit, such as an application specific integrated circuit (ASIC), a field programmable gate array (FPGA), or the like. The control unit 130 includes an acquiring unit 131, a correction unit 132, and a display processing unit 133 and implements or performs the function or the operation of the information processing described below. Furthermore, the internal configuration of the control unit 130 is not limited to the configuration illustrated in FIG. 1 but may also be another configuration as long as the information processing, which will be described later, is performed. Furthermore, in a description below, a line segment or a band shaped area associated with each product is also referred to as a trace graph and the entire graph including the trace graph associated with the time axis of each process and each product is referred to as a time line graph.

The acquiring unit 131 acquires log data from the various devices via the communication unit 110. The acquiring unit 131 stores the acquired log data in the log storage unit 122.

If operation information indicating that the time line graph is displayed is input from the operation unit 112 by an administrator, the acquiring unit 131 refers to the break time master 121 and determines whether a break time master related to a manufacturing area targeted for display is present. If the break time master is not present, the acquiring unit 131 creates a break time master. The acquiring unit 131 allows, for example, the display unit 111 to display an input screen of the break time and urges the administrator to input the break time. If the break time is input by the administrator, the acquiring unit 131 stores the input break time in the break time master 121. Furthermore, the acquiring unit 131 may also acquire the break time related to the subject manufacturing area from, for example, a device that manages on/off duty and automatically creates the break time master.

If the break time master is present, the acquiring unit 131 acquires the break time master in the manufacturing area targeted for display from the break time master 121. Namely, the acquiring unit 131 acquires information on the pause time slot of the work in the manufacturing area. If the acquiring unit 131 acquires or creates the break time master, the acquiring unit 131 determines whether the end time of the break time has elapsed. This determination determines that, if, for example, it is desired to see the time line graph of a one-day work performed in the manufacturing area on the previous day, all of the pieces of break time have elapsed. Furthermore, for example, if the break at noon on that day has been ended, it is determined that the break time in the morning and at noon has elapsed.

If the end time of the break time has not elapsed, i.e., no break time is present in the target period of time in the time line graph, the acquiring unit 131 waits until the first break time has elapsed. If the end time of the break time has elapsed, the acquiring unit 131 outputs, to the correction unit 132, a start instruction to start adjustment of the break time and the break time master with respect to the log data.

If the start instruction and the break time master are input from the acquiring unit 131, the correction unit 132 refers to the log storage unit 122 and determines whether the event data is present in the break time. If the event data is present in the break time, the correction unit 132 corrects the start and end time of the break time. For example, if the break time is 12:00 to 13:00 and if the event data indicating that a process has been ended at 12:01 is present, the correction unit 132 corrects the start time of the break time such that the start time is changed from 12:00 to 12:01. The correction unit 132 acquires the log data from the log storage unit 122 and inserts the corrected break time into the acquired log data. Namely, the correction unit 132 inserts, for example, the start event and the end event of the corrected break time. The correction unit 132 stores, in the correction log storage unit 123, the log data into which the break time has been inserted and then outputs a display instruction to the display processing unit 133.

If the event data is not present in the break time, the correction unit 132 acquires the log data from the log storage unit 122 without correcting the break time and then inserts the break time into the acquired log data. The correction unit 132 stores, in the correction log storage unit 123, the log data into which the break time has been inserted and then outputs the display instruction to the display processing unit 133.

FIG. 5 is a diagram illustrating an example of break time between processes. In the example illustrated in FIG. 5, a break B2 is inserted between the process A and the process B. At this time, for example, it is assumed that the end time T1 of the process A and the start time BS of the break B2 are the same. Furthermore, for example, it is assumed that the end time BE of the break B2 and the start time T2 of the process B are the same. Namely, both the process A and the process B are in the state in which, in the log data before the correction, the event time does not continue, whereas, in the log data after the correction, event time continues in the order of the process A, the break B2, and the process B. Furthermore, if a gap between process A and the process B is an interval of, for example, few minutes, it may also possible to insert the break B2 assuming that the event continues, whereas, if a gap between process A and the process B is equal to or greater than, for example, 10 minutes, it may also possible to insert the break B2 assuming that a break was present.

A description will be given here by referring back to FIG. 1. If a display instruction is input from the correction unit 132, the display processing unit 133 refers to the correction log storage unit 123 and creates a time line graph. Namely, the display processing unit 133 creates, based on the information on the start time and the end time of the manufacturing processes, a time line graph indicating the elapsed time from the start to the end of the manufacturing process of each of a plurality of manufacturing processes. Furthermore, regarding the created time line graph, the display processing unit 133 aligns the time axes in the state in which each of the time axes is divided into manufacturing processes in the order of execution of the plurality of manufacturing processes.

The display processing unit 133 creates the time axis that indicates the elapsed time in each of the processes and creates a line segment (trace graph) that connects the time axis for each product. The display processing unit 133 creates the orientation of the time axis in the order of, for example, time from top to bottom in the time line graph. The display processing unit 133 similarly creates a line segment for each product. Regarding the portion associated with the break time, the display processing unit 133 compresses the duration from the start time to the end time of the break time and sets the compressed portion to zero. Namely, the display processing unit 133 creates a time line graph in which no break time is present. Furthermore, the display processing unit 133 draws the line segment indicating the compressed break time on the time line graph. The display processing unit 133 creates a display screen including the time line graph, in which the time axes associated with the corresponding processes are arranged and the line segments associated with the corresponding products and break time are arranged, and then outputs and displays the created display screen onto the display unit 111.

Furthermore, the display processing unit 133 may also insert the portion associated with the break time so as to be distinguished from the working time slot in which work is performed. As a method of drawing a time line graph, first, the display processing unit 133 draws a graph in which a duration of the break time is set to zero by excluding the break time, i.e., by compressing the time axis. Then, the display processing unit 133 records the contact point of the line segment indicating pieces of the break time and trace graphs. Subsequently, the display processing unit 133 inserts pieces of the break time into the time line graph and draws the lines, which are parallel with the time axes, between the recorded points, i.e., between the trace graphs, that come into contact with the break time.

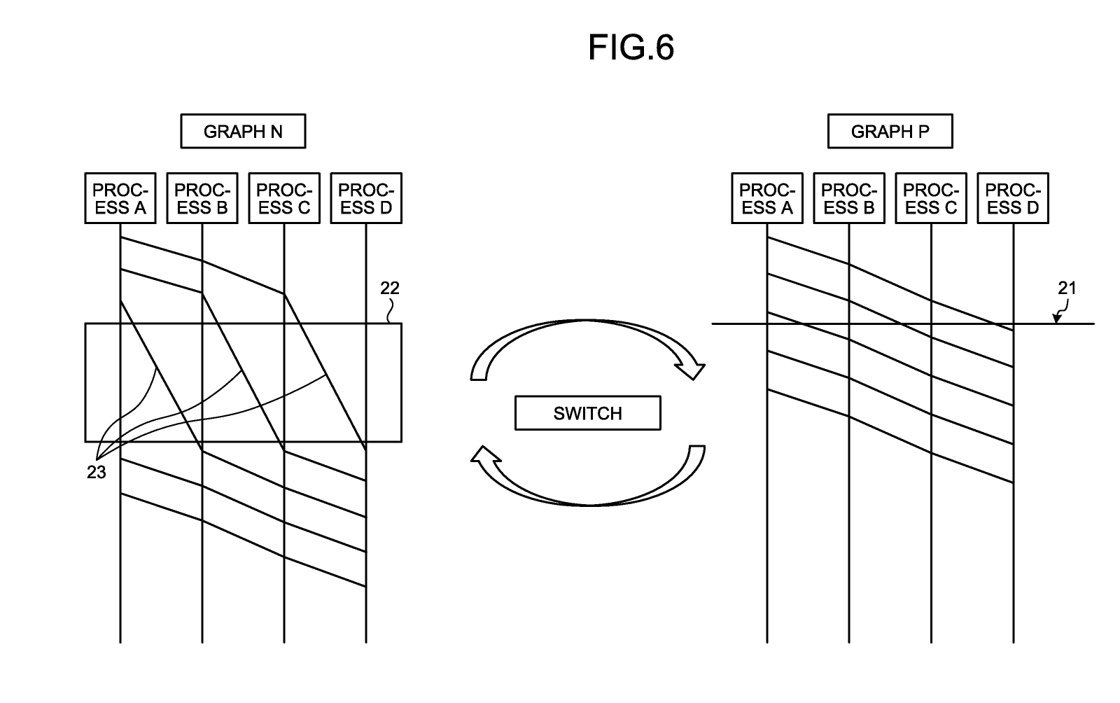

In the following, a normal display that displays the break time without compressing the time axis and a compression display that displays the break time by compressing the time axis will be described. FIG. 6 is a diagram illustrating an example of a graph in a case where break time is not considered at the time of normal display. In the example illustrated in FIG. 6, regarding a graph N with a normal display and a graph P with a compression display, the display thereof is switched by, for example, a switch button (not illustrated). In the graph P, each of the pieces of the break time is compressed and is displayed as a line segment 21. At this time, the trace graphs of the products each including the break time, i.e., the trace graphs of the products each intersecting with the line segment 21, are in the state in which the inclinations are not affected by the break time. In contrast, in the graph N, each of the pieces of the break time is not compressed and is displayed as a time slot 22. Consequently, because the trace graphs of the products each including the break time are drawn in the state in which the time slot 22 is included, the trace graphs are in the state in which, as indicated by graphs 23, the inclinations are affected by the break time and this state is accordingly sometimes erroneously determined to be abnormal. Furthermore, the graph N illustrated in FIG. 6 can be an example of a conventional time line graph.

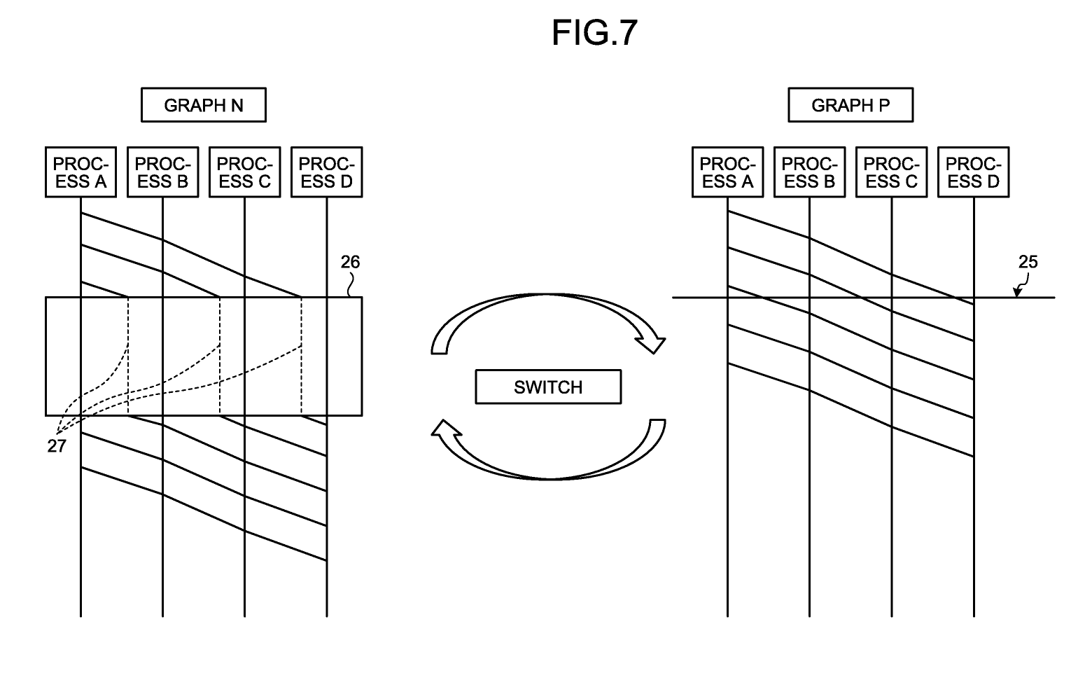

FIG. 7 is a diagram illustrating an example of a graph in a case where break time is considered at the time of normal display. In the example illustrated in FIG. 7, regarding the graph N with a normal display and the graph P with a compression display, the display thereof is switched by, for example, a switch button (not illustrated). In the graph P, each of the pieces of the break time is compressed and is displayed as a line segment 25. At this time, the trace graphs of the products each including the break time, i.e., the trace graphs of the products each intersecting with the line segment 25 are in the state in which the inclinations are not affected by the break time. In contrast, in the graph N, each of the pieces of the break time is not compressed; however, the trace graphs each including a time slot 26 that indicates the pieces of the break time are displayed by dotted lines 27 that are parallel with the time axes. Namely, the graph N illustrated in FIG. 7 is in the state in which, even if the pieces of the break time are displayed, the inclinations of the trace graphs are not changed and are not affected by the break time. Namely, in the graph N, the duration of the break time, i.e., the time slot 26, is inserted so as to be distinguished from the working time slot in which work is performed. In other words, in the graph N illustrated in FIG. 7, even if the break time is being displayed, it appears that time is not taken for production.

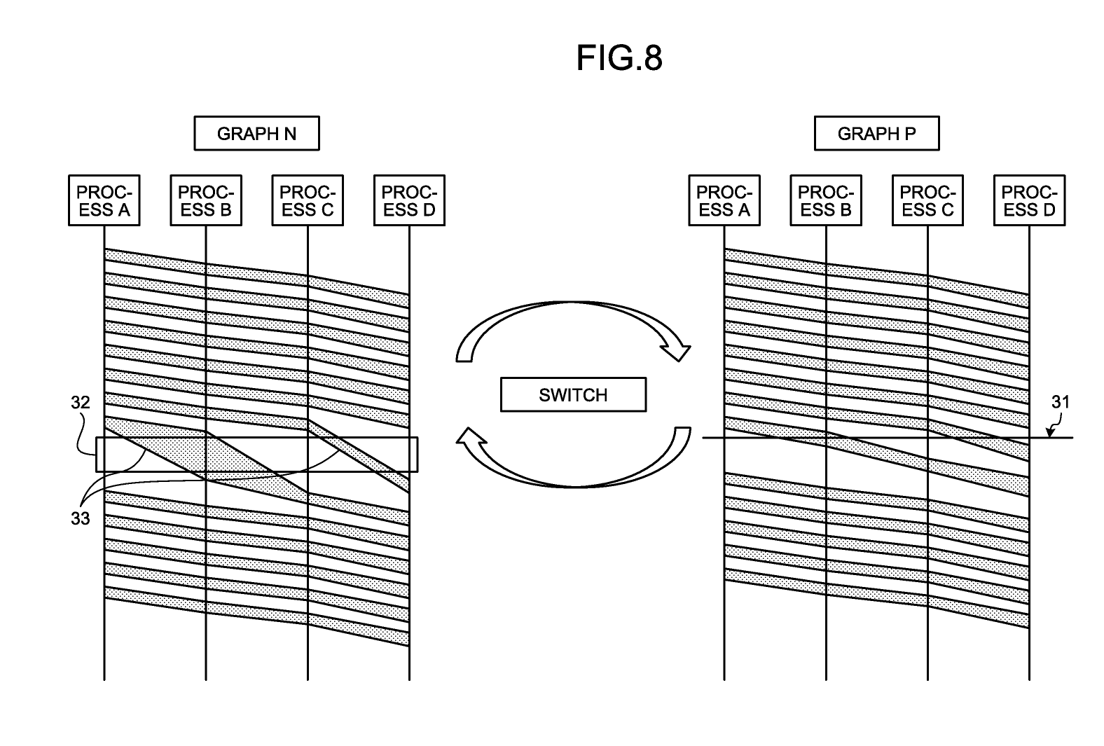

FIG. 8 is a diagram illustrating another example of a graph in a case where break time is not considered at the time of normal display. The time line graph illustrated in FIG. 8 is a graph that displays trace graphs each connecting the start time and the end time of each of the processes. In the example illustrated in FIG. 8, regarding the graph N with a normal display and the graph P with a compression display, the display thereof is switched by, for example, a switch button (not illustrated). In the graph P, each of the pieces of the break time is compressed and is displayed as a line segment 31. At this time, the trace graphs of the products each including the break time, i.e., the trace graphs of the products each intersecting with the line segment 31 are in the state in which the inclinations are not affected by the break time. In contrast, in the graph N, each of the pieces of the break time is not compressed and is displayed as a time slot 32. Consequently, because the trace graphs of the products each including the break time are drawn in the state in which the time slot 32 is included, the trace graphs are in the state in which, as indicated by graphs 33, the widths become great, the area thereof is thus increased, and this state is accordingly sometimes erroneously determined to be abnormal. Furthermore, the graph N illustrated in FIG. 8 can be an example of a conventional time line graph.

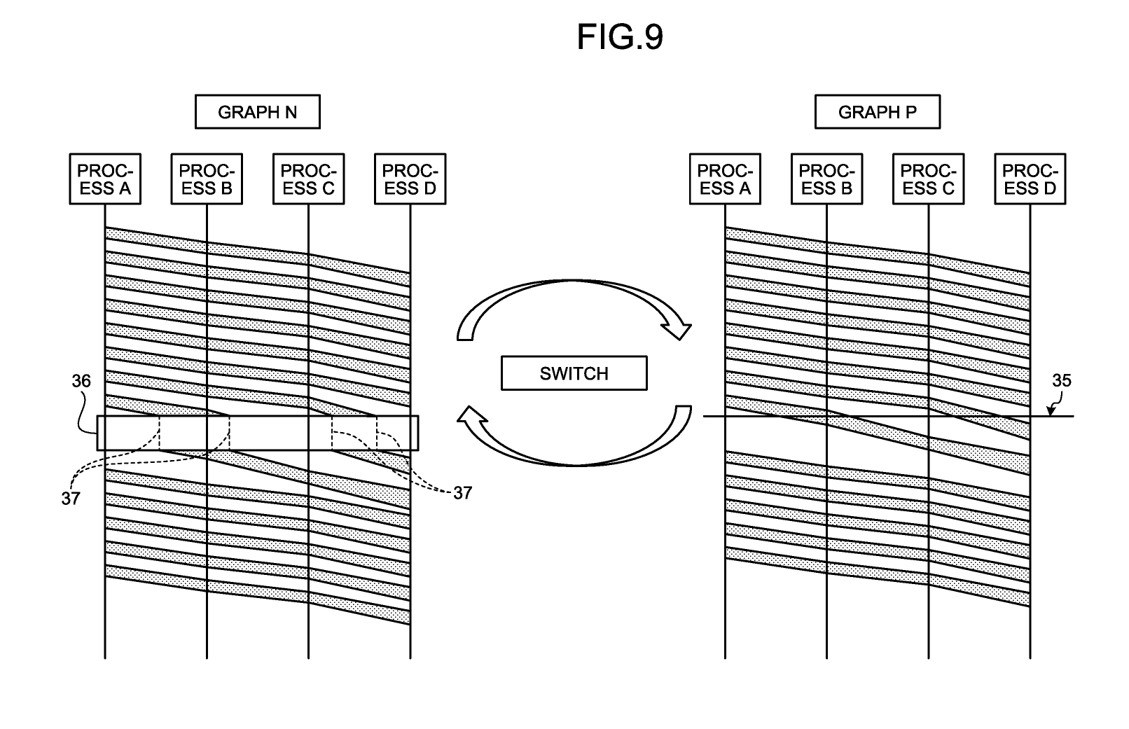

FIG. 9 is a diagram illustrating another example of a graph in a case where break time is considered at the time of normal display. The time line graph illustrated in FIG. 9 is a graph that displays trace graphs each connecting the start time and the end time of each of the processes. In the example illustrated in FIG. 9, regarding the graph N with a normal display and the graph P with a compression display, the display thereof is switched by, for example, a switch button (not illustrated). In the graph P, each of the pieces of the break time is compressed and is displayed as a line segment 35. At this time, the trace graphs of the products each including the break time, i.e., the trace graphs of the products each intersecting with the line segment 35 are in the state in which the inclinations are not affected by the break time. In contrast, in the graph N, the trace graphs in each of which the break time is not compressed but each include a time slot 36 that indicates the break time are displayed by dotted lines 37 that are parallel with the time axes. Namely, in the graph N illustrated in FIG. 9, because the inclinations of the trace graphs are not changed even if the break time is displayed and the area thereof is not increased and thus this state is not affected by the break time. Namely, in the graph N, the duration of the break time, i.e., the time slot 36, is inserted so as to be distinguished from the working time slot in which work is performed. In other words, in the graph N illustrated in FIG. 9, even if the break time is being displayed, it appears that time is not taken for production.

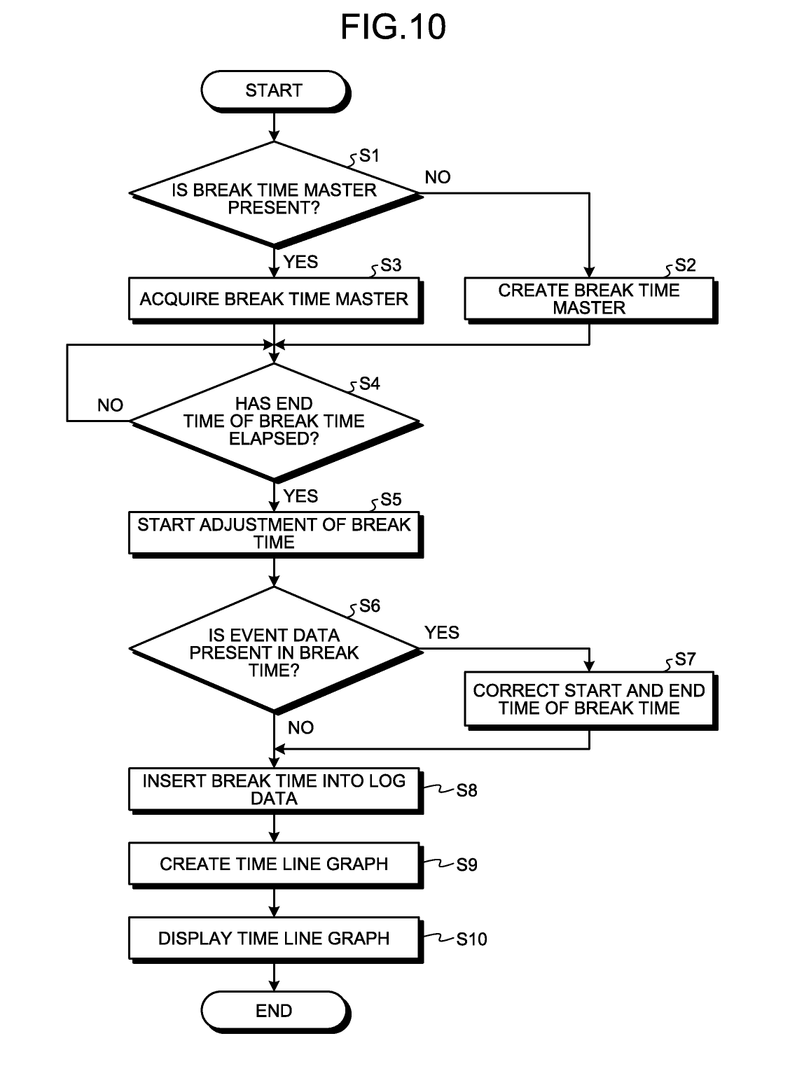

In the following, the operation of the management system 1 according to the embodiment will be described. FIG. 10 is a flowchart illustrating an example of display processing according to the embodiment.

If the operation information indicating that the time line graph is displayed is input by an administrator from the operation unit 112, the acquiring unit 131 in the management device 100 refers to the break time master 121 and determines whether the break time master in the manufacturing area targeted for a display is present (Step S1). If the break time master is not present (No at Step S1), the acquiring unit 131 creates a break time master (Step S2). If the break time master is present (Yes at Step S1), the acquiring unit 131 acquires, from the break time master 121, the break time master in the manufacturing area targeted for the display (Step S3).

If the acquiring unit 131 acquires or creates the break time master, the acquiring unit 131 determines whether the end time of the break time has elapsed (Step S4). If the end time of the break time has not elapsed (No at Step S4), the acquiring unit 131 repeats the determination performed at Step S4 until the break time elapses. If the end time of the break time has elapsed (Yes at Step S4), the acquiring unit 131 outputs, to the correction unit 132, the start instruction to start adjustment of the break time with respect to the log data and the break time master (Step S5).

If the start instruction and the break time master are input from the acquiring unit 131, the correction unit 132 refers to the log storage unit 122 and determines whether the event data is present in the break time (Step S6). If the event data is present in the break time (Yes at Step S6), the correction unit 132 corrects the start and end time of the break time (Step S7). The correction unit 132 acquires the log data from the log storage unit 122 and inserts the corrected break time into the acquired log data (Step S8).

If the event data is not present in the break time (No at Step S6), the correction unit 132 acquires the log data from the log storage unit 122 without correcting the break time and inserts the break time into the acquired log data (Step S8). The correction unit 132 stores, in the correction log storage unit 123, the log data into which the break time is inserted and then outputs the display instruction to the display processing unit 133.

If the display instruction is input from the correction unit 132, the display processing unit 133 refers to the correction log storage unit 123 and creates the time line graph (Step S9). Namely, the display processing unit 133 creates a display screen that includes the time line graph in which the time axis that is associated with each of the processes and the line segment that is associated with each of the products and pieces of the break time are disposed and then outputs and displays the created display screen onto the display unit 111 (Step S10). Consequently, the management device 100 can display the temporal transition of the manufacturing process by taking the pause time into consideration.

In this way, the management device 100 acquires the information on the pause time slot of the work in the manufacturing area. Furthermore, when the management device 100 displays, based on the sensor information, the temporal transition of the manufacturing process on the time axis, the management device 100 compresses the duration from the start time to the end time of the acquired pause time slot and displays the duration on the display unit 111. Consequently, it is possible to display the temporal transition of the manufacturing process by taking the pause time into consideration.

Furthermore, the management device 100 performs compression such that the duration becomes zero.

Consequently, because the inclinations and the area of the trace graph are not affected by the pause time, for example, it is possible to easily compare a plurality of time line graphs in a plurality of manufacturing areas that have different break time slots.

Furthermore, the management device 100 inserts the duration in distinction from the working time slot in which work is performed. Consequently, it is possible to display the temporal transition of the manufacturing process such that the inclination and the area of the trace graph are not affected by the pause time even if the pause time is displayed.

Furthermore, in the management device 100, the sensor information is information on an RFID tag attached to the product manufactured in the manufacturing area. Consequently, it is possible to easily manage the start time and the end time of each of the processes of the products.

Furthermore, in the management device 100, the sensor information is an operation log of a device in a manufacturing area. Consequently, it is possible to display the temporal transition of the manufacturing processes on the time axes by efficiently using the track record data that is based on the operations of workers in each of the processes.

Furthermore, when the management device 100 creates a time line graph, the process that is longer than the reference value may also be highlighted. Specifically, the management device 100 may also calculate, based on the start time and the end time of each of the processes, the working time in each of the processes; compare and determine the calculated working time with the reference value of each of the processes; and highlight the process with the working time that is longer than that of the reference value as an abnormal value of the working time. Consequently, an administrator can immediately check the process in which the work is highly likely to be abnormal.

In this case, if the break time is not taken into account, the break time is inserted in the middle of the process although the actual working time is not abnormal and, consequently, the process is highlighted as abnormality of the working time. Thus, the management device 100 may also correct the working time based on the start time and the end time of the process and based on the start time and the end time of the break time and then perform comparison and determination of the working time and the reference value.

Furthermore, the method of detecting the abnormal value of the working time is not limited to the comparison and determination of the working time and the reference value. For example, the management device 100 may also detect the value based on the length or the inclination of the line segment of each of the processes in the time line graph.

Furthermore, in the embodiment described above, the break time is used as an example of the pause time slot of work; however, the embodiment is not limited to this. For example, in a manufacturing process in which maintenance is performed during work after a certain number of products has been manufactured, it may also possible to display the time line graph by compressing the maintenance time as the pause time slot of the work.

Furthermore, the components of each unit illustrated in the drawings are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the correction unit 132 and the display processing unit 133 may also be integrated. Furthermore, each of the process illustrated in the drawings is not limited to the order described above and may also be simultaneously performed or may also be performed by changing the order of the processes as long as the processes do not conflict with each other.

Furthermore, all or any part of various processing functions performed by each unit may also be executed by a CPU (or a microcomputer, such as an MPU, a micro controller unit (MCU), or the like). Furthermore, all or any part of various processing functions may also be, of course, executed by programs analyzed and executed by the CPU (or the microcomputer, such as the MPU or the MCU), or executed by hardware by wired logic.

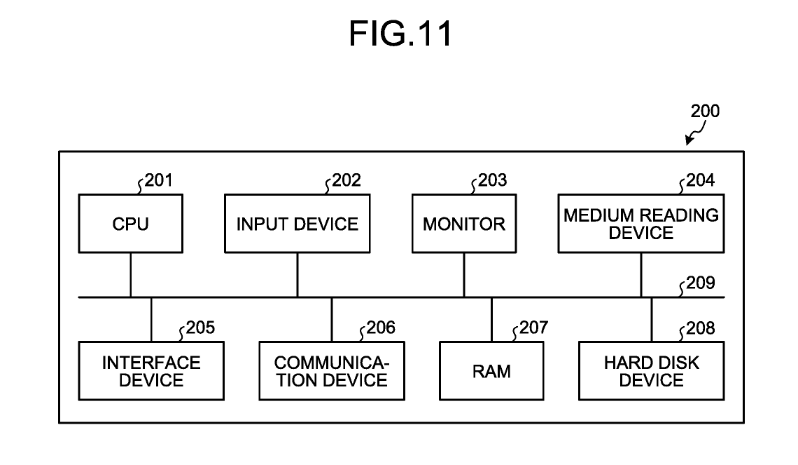

The various processes described in the above embodiments can be implemented by programs prepared in advance and executed by a computer. Accordingly, in the following, an example of a computer that executes programs having the same function as that described in the embodiments described above will be described. FIG. 11 is a diagram illustrating an example of a computer that executes a management program.

As illustrated in FIG. 11, a computer 200 includes a CPU 201 that executes various kinds of arithmetic processing, an input device 202 that receives an input of data, and a monitor 203. Furthermore, the computer 200 includes a medium reading device 204 that reads programs or the like from a storage medium, an interface device 205 that is used to connect various devices, and a communication device 206 that is used to connect to the other information processing apparatuses in a wired or wireless manner. Furthermore, the computer 200 includes a RAM 207 that temporarily stores therein various kinds of information and a hard disk device 208. Furthermore, each of the devices 201 to 208 is connected to a bus 209.

The hard disk device 208 stores therein a management program having the same function as that performed by each of the processing units, such as the acquiring unit 131, the correction unit 132, and the display processing unit 133 illustrated in FIG. 1. Furthermore, the hard disk device 208 stores therein the break time master 121, the log storage unit 122, the correction log storage unit 123, and various kinds of data that implements the management program. The input device 202 receives an input of various kinds of information, such as operation information, management information, and the like, from, for example, an administrator of the computer 200. The monitor 203 displays, for example, display screen, the screen of the management information and various screens with respect to the administrator of the computer 200. For example, a printer or the like is connected to the interface device 205. The communication device 206 has the same function as that performed by, for example, the communication unit 110 illustrated in FIG. 1, is connected to a network (not illustrated), and sends and receives various kinds of information to and from various devices.

The CPU 201 reads each of the programs stored in the hard disk device 208 and loads and executes the programs in the RAM 207, thereby executing various kinds of processing. Furthermore, these programs can allow the computer 200 to function as the acquiring unit 131, the correction unit 132, and the display processing unit 133 illustrated in FIG. 1.

Furthermore, the management program described above does not always need to be stored in the hard disk device 208. For example, the computer 200 may also read and execute the program stored in a storage medium that can be read by the computer 200. Examples of the computer 200 readable storage medium include a portable recording medium, such as a CD-ROM, a DVD disk, a universal serial bus (USB) memory, or the like, a semiconductor memory, such as a flash memory or the like, and a hard disk drive. Furthermore, the management program may also be stored in a device connected to a public circuit, the Internet, a LAN, or the like and execute the management program from the recording medium described above.

It is possible to display temporal transition of a manufacturing process by taking the pause time into consideration.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A management system that performs, based on sensor information received from a sensor disposed in a manufacturing area, process management in the manufacturing area, the management system comprising:
a memory; and
a processor coupled to the memory, wherein the processor executes a process comprising:
acquiring information on a pause time slot of work in the manufacturing area; and
displaying, when displaying temporal transition of a manufacturing process on a time axis based on the sensor information, the temporal transition on a display after having compressed duration from a start time to an end time of the acquired pause time slot.

2. The management system according to claim 1, wherein the displaying includes compressing the duration so as to be zero.

3. The management system according to claim 1, wherein the displaying includes inserting the duration so as to be distinguished from a working time slot in which the work is performed.

4. The management system according to claim 1, wherein the sensor information is information on an RFID tag that is attached to a product manufactured in the manufacturing area.

5. The management system according to claim 1, wherein the sensor information is an operation log of a device in the manufacturing area.

6. A management method of performing, based on sensor information received from a sensor disposed in a manufacturing area, process management in the manufacturing area, the management method performed comprising:
acquiring information on a pause time slot of work in the manufacturing area, using a processor; and
displaying, when displaying temporal transition of a manufacturing process on a time axis based on the sensor information, the temporal transition on a display after having compressed duration from a start time to an end time of the acquired pause time slot, using the processor.

7. The management method according to claim 6, wherein the displaying includes compressing the duration so as to be zero.

8. The management method according to claim 6, wherein the displaying includes inserting the duration so as to be distinguished from a working time slot in which the work is performed.

9. The management method according to claim 6, wherein the sensor information is information on an RFID tag that is attached to a product manufactured in the manufacturing area.

10. The management method according to claim 6, wherein the sensor information is an operation log of a device in the manufacturing area.

11. A non-transitory computer-readable recording medium having stored therein a management program for a process management executed in a manufacturing area based on sensor information received from a sensor disposed in the manufacturing area, the management program that causes a computer to execute the process comprising:
acquiring information on a pause time slot of work in the manufacturing area; and
displaying, when displaying temporal transition of a manufacturing process on a time axis based on the sensor information, the temporal transition on a display after having compressed duration from a start time to an end time of the acquired pause time slot.

12. The non-transitory computer-readable recording medium according to claim 11, wherein the displaying includes compressing the duration so as to be zero.

13. The non-transitory computer-readable recording medium according to claim 11, wherein the displaying includes inserting the duration so as to be distinguished from a working time slot in which the work is performed.

14. The non-transitory computer-readable recording medium according to claim 11, wherein the sensor information is information on an RFID tag that is attached to a product manufactured in the manufacturing area.

15. The non-transitory computer-readable recording medium according to claim 11, wherein the sensor information is an operation log of a device in the manufacturing area.
